(19) United States
(12) Patent Application Publication
(10) Pub. No.: US 2011/0050560 A1
(43) Pub. Date: Mar. 3, 2011

(54) Thin Electronic Reader Device

(75) Inventors: Mark J. Foster, Palo Alto, CA (US); Muhammad Kashif Imam, New York, NY (US); Serge Rutman, Boulder Creek, CA (US)

(73) Assignee: FIRSTPAPER LLC, NEW YORK, NY (US)

(21) Appl. No.: 12/549,785

(22) Filed: Aug. 28, 2009

(51) Int. Cl. G09G 3/34

(52) U.S. Cl. 345/107

(57) ABSTRACT

A thin electronic reader device is provided. The electronic reader device may have a reduced thickness. The device may comprise a top case housing having a front side and a back side. The device may also comprise a bottom case housing having a front side and a back side. The front side of the bottom case housing may be removably attached to the back side of the top case housing. The device may further comprise an electronic paper display nested within the top case housing. The electronic paper display may be adapted to display viewable images. The device may additionally comprise an interactive screen that may be affixed to the front side of the top case housing. The interactive screen may be adapted to overlie the electronic paper display.

### FIELD OF THE INVENTION

The present invention relates generally to the field of electronic reading devices and in particular to thin electronic reader devices.

### BACKGROUND OF THE INVENTION

Electronic reader devices are popular devices that include many different features. Electronic reader devices allow the user to read books, newspapers, magazines and other publications directly on the electronic device. Many of these devices also include features such as text-to-speech and wireless internet access. Some of these devices include Amazon's Kindle and Sony's digital book reader. However, existing electronic reader devices are generally bulky and are not thin enough for optimal user comfortability and use.

### SUMMARY OF THE INVENTION

The present invention generally relates to thin electronic reader devices. Aspects of the invention provide an electronic reader device. The device may comprise a top case housing having a front side and a back side. The device may also comprise a bottom case housing having a front side and a back side. The front side of the bottom case housing may be removably attached to the back side of the top case housing. The device may further comprise an electronic paper display within the top case housing. The electronic paper display may be adapted to display viewable images. The device may additionally comprise an interactive screen that may be affixed to the front side of the top case housing. The interactive screen may be adapted to overlie the electronic paper display. The electronic reader device may have a reduced thickness. The electronic reader device may be configured to be no more than 0.35 inches thick.

It is to be understood that both the foregoing general description and the following detailed description are exemplary and explanatory only, and are not restrictive of the invention as claimed. The accompanying drawings constitute a part of the specification, illustrate certain embodiments of the invention and, together with the detailed description, serve to explain the principles of the invention.

### BRIEF DESCRIPTION OF THE DRAWINGS

The present invention, together with further objects and advantages, may be more fully understood by reference to the following detailed description taken in conjunction with the accompanying drawings, in the several figures of which like reference indicators identify like elements, and in which:

FIG. 1 is an illustration of a thin electronic reader device according to an embodiment;

FIG. 2 is an illustration of a cross-sectional view of a thin electronic reader device according to an embodiment;

FIG. 3 is an illustration of a cross-sectional view of a thin electronic reader device according to an embodiment;

FIG. 4 is an illustration of a detailed cross-sectional view of a thin electronic reader device according to an embodiment;

FIG. 5 is an illustration of a detailed cross-sectional view of a thin electronic reader device according to an embodiment;

FIG. 6 is an illustration of a detailed cross-sectional view of a thin electronic reader device according to an embodiment;

FIG. 7 is an illustration of an exploded view of a thin electronic reader device according to an embodiment;

FIG. 8 is an illustration of a detailed view of a top case housing of a thin electronic reader device according to an embodiment;

FIG. 9 is an illustration of a detailed view of a top case housing of a thin electronic reader device according to an embodiment;

FIG. 10 is an illustration of a detailed view of an interactive screen of a thin electronic reader device according to an embodiment;

FIG. 11 is an illustration of a detailed view of a bottom case housing of a thin electronic reader device according to an embodiment;

FIG. 12 is an illustration of a detailed view of an audio jack of a thin electronic reader device according to an embodiment;

FIG. 13 is an illustration of a detailed view of an audio jack of a thin electronic reader device according to an embodiment; and

FIG. 14 is an illustration of a detailed view of a Radio Frequency shield of a thin electronic reader device according to an embodiment.

### DETAILED DESCRIPTION OF THE INVENTION

Electronic reader devices have become popular consumer devices. It is well known in the art that electronic reader devices may be used for reading books, magazines, newspapers and other publications. Electronic reader devices of the prior art are generally bulky and have a large thickness or depth. This can lead to problems with user comfortability and use of the electronic reader device. Electronic readers of the prior art are generally bulky because they require a top upper housing to cover the display of the electronic reader device. This top upper housing maintains the stability of the electronic reader device. Therefore, it would be desirable to provide a thin electronic reader device that enhances user comfortability, portability, and the design of the electronic reader device.

Some embodiments of the present invention provide for a thin electronic reader device. Although the electronic reader device may have any thickness or depth, the thin electronic reader device has a reduced thickness or depth. In some embodiments, the thickness of the electronic reader device may be no more than 0.35 inches. In other embodiments, the thickness of the electronic reader device may be between 0.04 to 0.35 inches.

In some embodiments, the electronic reader device may include three parts to provide a sustainable assembly. These parts may be a top case housing, a bottom case housing, and an interactive screen. In some embodiments, the electronic reader device may only require two parts to maintain a sustainable assembly. These parts may be an interactive screen and a top case housing or a bottom case housing. Unlike conventional electronic reader devices, some embodiments of the present invention may not require a conventional top upper housing that covers the display and holds or sustains the electronic reader device.

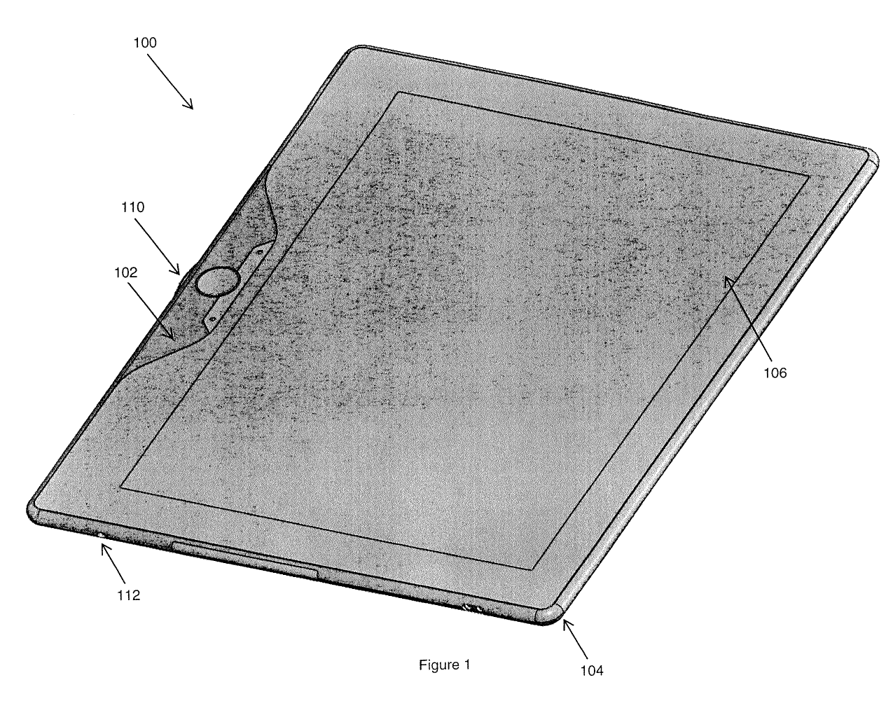

FIG. 1 is an illustration of a thin electronic reader device 100 according to an embodiment. As illustrated, the thin electronic reader device 100 may have a top case housing 102, a bottom case housing 104, an interactive screen 106, a movable wheel 110, and an audio jack 112.

The top case housing 102 has a front side and back side. The bottom case housing 104 also has a front side and a back side. The bottom case housing 104 is attached to the top case housing 102. In some embodiments, the front side of the bottom case housing 104 is attached to the back side of the top case housing 102. The bottom case housing 104 may be removably attached to the top case housing 102. In some embodiments, the bottom case housing 104 may be permanently attached to the top case housing 102. The bottom case housing 104 may be attached to the top case housing 102 using a connector. The connector may be screw(s), glue, adhesive, bonding, or any other attachment mechanism.

The top case housing 102 may be manufactured using numerous methods. In some embodiments, the top case housing 102 may be manufactured using a die casting method. In some embodiments, the top case housing 102 may be manufactured using a insert molding method. The top case housing 102 may be made from many different substances. The top case housing 102 may be made from a non-ferrous metal or ferrous metal. In some embodiments, the top case housing 102 may be made of zinc, copper, aluminum, magnesium or tin.

The top case housing 102 may form the structural core of the electronic reader device 100. The top case housing 102 may have any shape, size or thickness. The top case housing 102 may have a reduced thickness. In some embodiments, the top case housing 102 may have a consistent thickness between 0.2 mm and 0.5 mm in certain parts.

The top case housing 102 may have a bull-nose radius. The bull-nose radius may provide structural integrity for the electronic reader device 100. The bull-nose radius may also provide an almost contiguous metal frame all around the electronic reader device 100.

The top case housing 102 may have a grip area that is integral to the housing 102. The grip area may be made of metal or any other material. The grip area may provide a point about which the center of gravity of the electronic reader device 100 can pivot. The mechanical stress that occurs when a users holds the electronic reader device 100 may fall on the grip area. The use of a grip area may enable the electronic reader device 100 to have a reduced thickness.

The bottom case housing 104 may have any shape, size or thickness. The bottom case housing 104 may have reduced thickness. The bottom case housing 104 may be no more than 1 mm thick. In some embodiments, the bottom case housing 104 may have a thickness between 0.50 mm and 0.70 mm. The bottom case housing 104 may be manufactured using numerous methods. The bottom case housing 104 may be made from many different substances. The bottom case housing 104 may be made from a non-ferrous metal or ferrous metal. In some embodiments, the bottom case housing 104 may be made of zinc, copper, aluminum, magnesium or tin.

The interactive screen 106 may be attached to the top case housing 102. The interactive screen 106 may be affixed to the front side of the top case housing 102. In some embodiments, the interactive screen 106 may be attached to the bottom case housing 104. The interactive screen 106 may be affixed to the front side of the bottom case housing 104. When attached to the top case housing 102 and/or the bottom case housing 104, the face of the interactive screen may be substantially even or level with the front side of the top case housing 102. In some embodiments, the face of the interactive screen 106 may be substantially lower than the front side of the top case housing 102.

In some embodiments, the interactive screen 106 may be flush mounted. The bottom case housing 104 may also be flush mounted. The flush mounted interactive screen 106 and bottom case housing 104 may result in the electronic reader device 100 having a substantially flat face. The flush mounted interactive screen 106 and bottom case housing 104 may reduce the thickness of the electronic reader device 100.

The interactive screen 106 may allow a user of the electronic reader device 100 to interact with the device 100. The interactive screen 106 may be any kind of display. In some embodiments, the interactive screen 106 may be a touchscreen.

A movable wheel 110 may be attached to the top case housing 102. The moveable wheel 110 may be capable of allowing a user to interact with the electronic reader device 100. In some embodiments, the moveable wheel 110 may allow a user of the electronic reader device 100 to turn a page of an electronic publication that is viewable in the electronic reader device 100. A user may use the moveable wheel 110 to turn a page by using a controller with a very thin form factor. For example, a user that is reading an electronic book on the electronic reader device 100 may rotate the moveable wheel 110 clockwise in order to turn one or multiple pages forward in the book. Alternatively, the user may rotate the moveable wheel 110 counterclockwise in order to turn one or multiple pages back in the book. In some embodiments, the moveable wheel 110 may allow a user of the electronic reader device 100 to navigate the internet. Although, FIG. 1 illustrates a moveable wheel 110 there are many other devices that may be used to allow the user to interact with the electronic reader device 100. The electronic reader device 100 may include buttons, a pad, or any other method of interacting with a device.

The audio jack 112 may be attached to the top case housing 102. In some embodiments, the audio jack 112 may be attached to the top case housing 102 and/or the bottom case housing 104. The audio jack 112 may have a sufficient thickness or depth in order to fit within the electronic reader device 100. The audio jack 112 may have sufficient stability to remain attached to the top case housing 102 before, during and/or after use. This may prevent a user from prying open the electronic reader device 100 if the audio jack 112 is twisted or leveraged. The audio jack 112 may be able to permit audible sound from the electronic reader device 100. The audio jack 112 may also be used to permit recording to the electronic reader device 100.

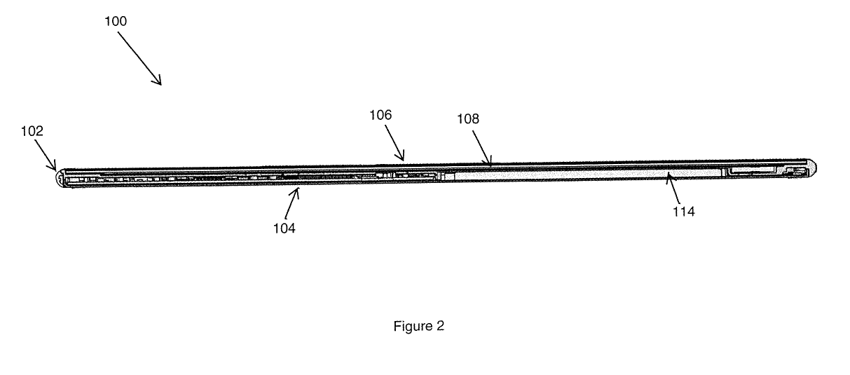

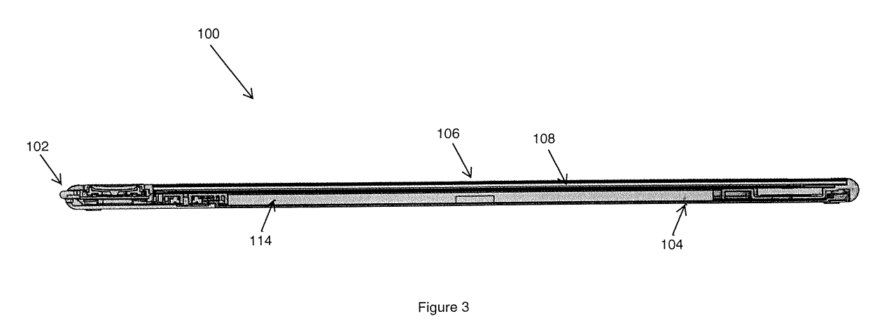

FIGS. 2 and 3 are illustrations of a cross-sectional view of the thin electronic reader device 100 according to an embodiment. FIG. 2 is a side cross-sectional view and FIG. 3 is a middle cross-sectional view. As illustrated, in some embodiments, the electronic reader device 100 may have a battery 114. The electronic reader devise 100 may also have an electronic paper display 108, such as electrophoretic displays or electro-wetting displays. Examples of such displays include those disclosed in U.S. Pat. Nos. 6,577,433, 6,529,313, 6,525,866, 6,574,034, 6,017,584, 6,067,185, 6,118,426, 6,120,839, 6,124,851, 6,130,774, 6,172,798, 6,177,921, 6,232,950 and 6,249,271.

An electronic paper display 108 may use electrostatic forces to create images. A single electronic paper display 108 may utilize positive, negative and neutral voltages to affect image depictions and image changes. More particularly, each electronic paper display 108 pixel may receive (at different times) positive, negative or neutral voltages, which, in combination, select the color or shade of gray embodied in such pixel. The electronic paper display 108 may be persistent (i.e., state bistable) in that its retains its displayed image in the absence of power.

The electronic paper display 108 may be nested within the top case housing 102. The electronic paper display 108 may be used to display viewable images. The electronic paper display 108 may display content in accordance with the electronic reader device 100. The electronic paper display 108 may be a panel with e-ink. The electronic paper display 108 may be overlaid by the interactive screen 106. The electronic paper display 108 may permit the user of the electronic reader device 100 to interact with the interactive screen 106.

The electronic panel display 108 may have a controller. An exemplary such electronic panel display 108 and electronic display controller is disclosed in U.S. patent application Ser. No. 12/497,199 entitled “Electronic Display Controller,” filed Jul. 2, 2009, the contents of which are hereby incorporated by reference. The electronic panel display 108 and/or controller may be coupled to the interactive screen 106 via an interface, such as a Recommended Standard 232 (RS-232) interface. In some embodiments, the interactive screen 106 component may be coextensive with electronic panel display 108. That is, electronic panel display 108, may include touch screen capabilities by way of incorporation of the interactive screen 106. An exemplary such electronic panel display 108 is disclosed in U.S. patent application Ser. No. 12/332,860 entitled “Touch-Sensitive Illuminated Display,” filed Dec. 11, 2008, the contents of which are hereby incorporated by reference.

The battery 114 may supply power to the electronic reader device 100. The battery 114 may be have a reduced thickness in order to fit within the electronic reader device 100. The battery 114 may be removably attached to the top case housing 102 and/or the bottom case housing 104. The battery 114 may be positioned within the device 100 to be removable and/or replaceable. In some embodiments, the battery 114 may be manufactured by Gold Peak Batteries and have a model number of NTA2595.

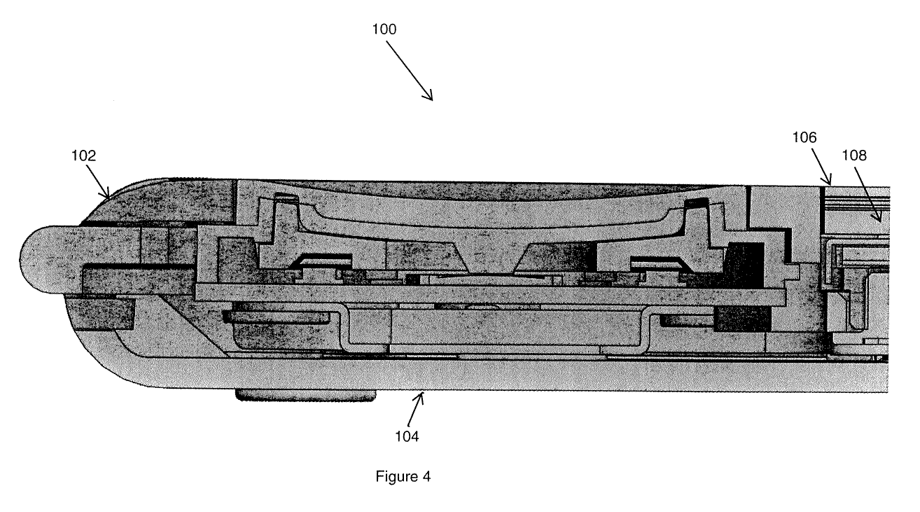

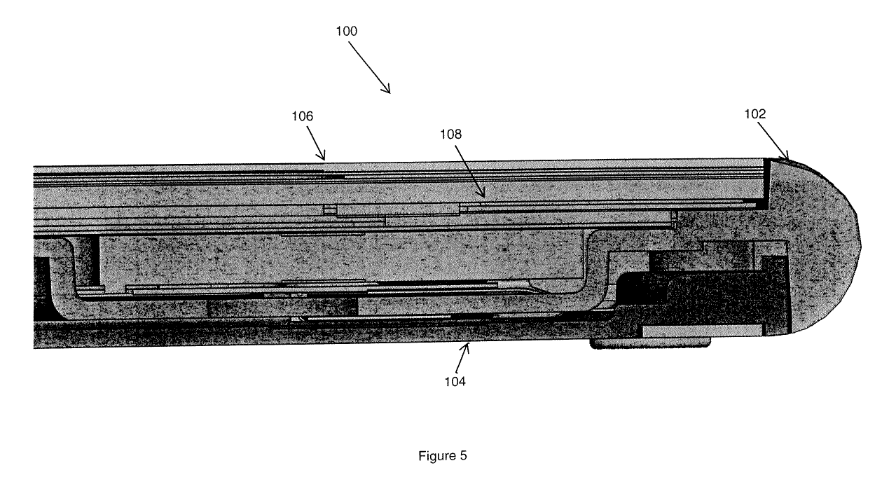

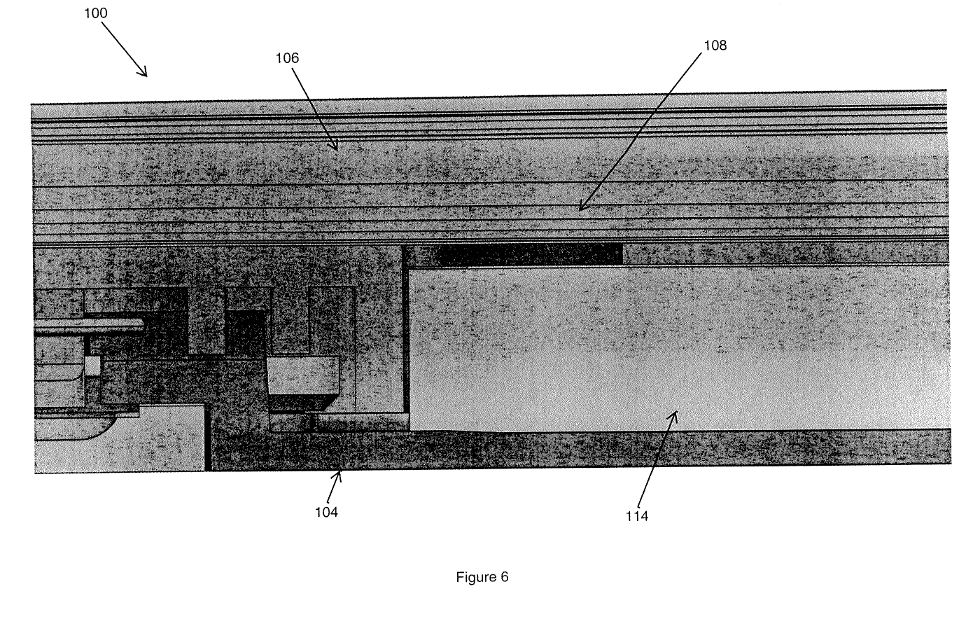

FIGS. 4, 5 and 6 are illustrations of a detailed cross-sectional view of a thin electronic reader device 100 according to an embodiment. These figures provide a detailed view of the top case housing 102, bottom case housing 104, interactive screen 106, and electronic paper display 108. FIG. 6 additionally provides a detailed view of the battery 114.

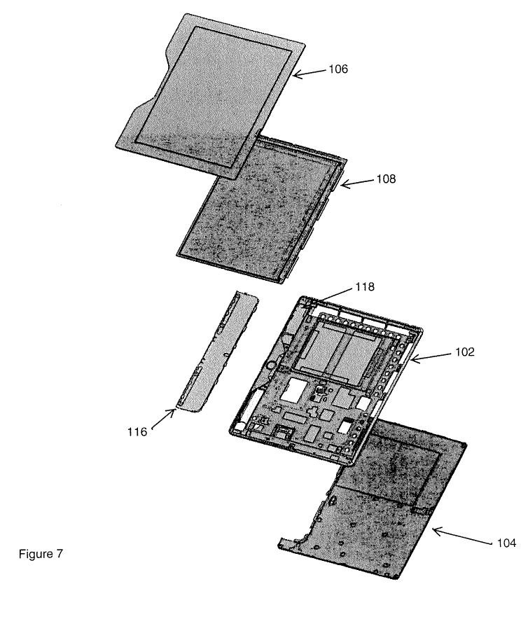

FIG. 7 is an illustration of an exploded view of a thin electronic reader device 100 according to an embodiment. As illustrated, the electronic reader device 100 may have a top case housing 102, a bottom case housing 104, an interactive screen 106, and an electronic paper display 108. As illustrated, the electronic reader device 100 may also have an antenna cover 116. The antenna cover 116 may be used to cover an antenna. The antenna cover 116 may be attached to the bottom case housing and/or the top case housing. In some embodiments, the antenna cover 116 may be attached to the back side of the top case housing 102. In another embodiment, the antenna cover 116 may be attached to the front side of the top case housing 102.

The electronic reader device 100 may have a Radio Frequency (RF) shield 118. The RF shield 118 may be connected to the top case housing 102 and/or the bottom case housing 104. In some embodiments, the RF shield 118 may be connected to the front side of the top case housing 102. The RF shield 118 may be positioned to overlie the antenna.

The antenna of the electronic reader device 100 may be capable of receiving and transmitting communication signals. The antenna may transmit and receive the communication signals received and transmitted over a communications network. The communications network may be a wireless, satellite, cellular, internet, wi-fi, bluetooth, RF, RFID and/or any other kind of network. The antenna may be attached to the top case housing 102 and/or bottom case housing 104. In some embodiments, the antenna may be placed over the antenna cover 116.

FIG. 7 also illustrates how the electronic reader device 100 may be constructed. The top case housing 102 overlies the bottom case housing 104, the antenna cover 116 is attached to the top case housing 102 and the bottom case housing 104, the RF shield 118 is attached to the top case housing 102, the electronic paper display 108 is nested within the top case housing 102, and the interactive screen 106 overlies the electronic paper display 108. In some embodiments, the interactive screen 106 is level or nested within the top case housing 102.

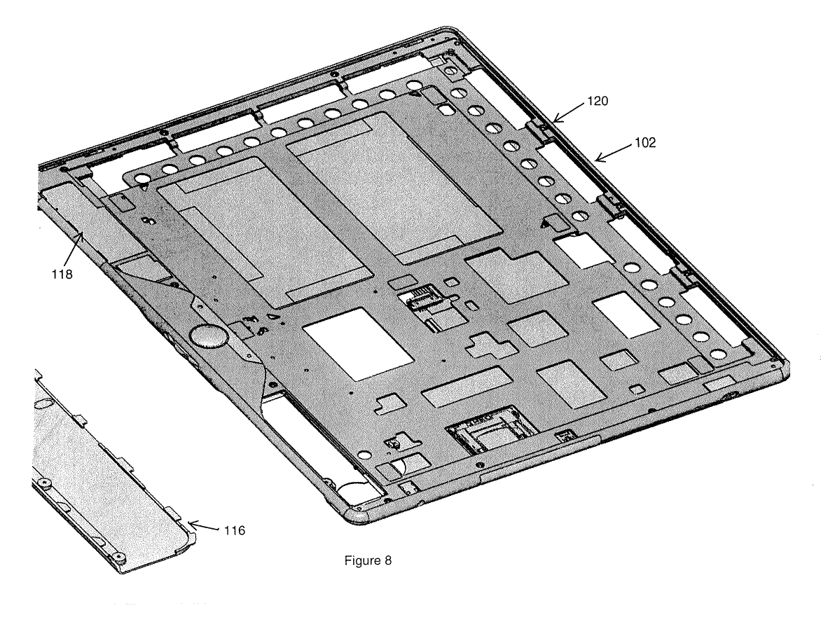

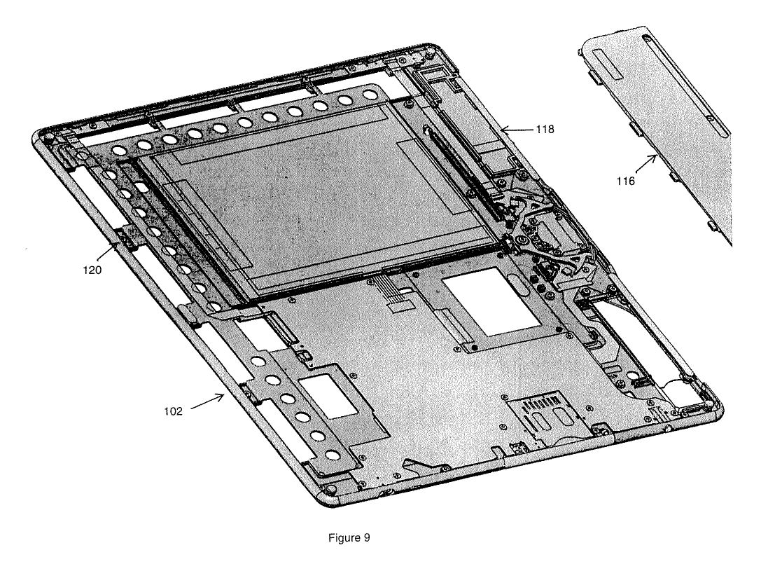

FIGS. 8 and 9 are illustrations of a detailed view of a top case housing 102 of a thin electronic reader device 100 according to an embodiment. FIG. 8 illustrates the front side of the top case housing 102. FIG. 9 illustrates the back side of the top case housing 102. As illustrated, the top case housing 102 may include one or more connection points 120 where a connector may be attached.

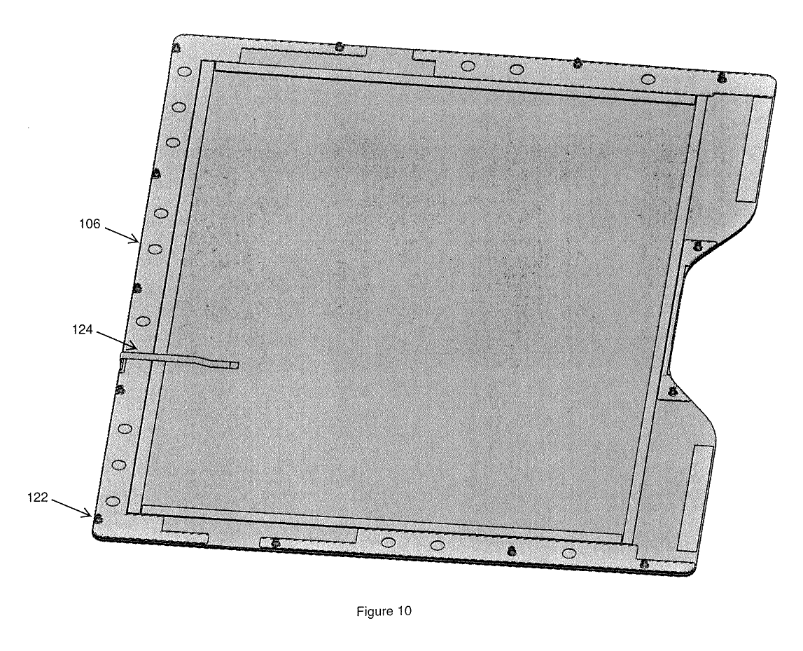

FIG. 10 is an illustration of a detailed view of an interactive screen 106 of a thin electronic reader device 100 according to an embodiment. The interactive screen 106 may have a front side and a back side. The interactive screen 106 may also have a border. The border may be masked. The border may also be painted or silk-screened. In some embodiments, the border is painted or silk-screened on the back side of the interactive screen 106. The interactive screen 106 may also include one or more bosses 122. Alternatively, the interactive screen 106 may use any other attachment mechanism instead of bosses 122. The bosses 122 may be glue-bonded to the front side or back side of the interactive screen 106.

The interactive screen 106 may also have a flexible printed circuit (FPC) connector 124. The FPC connector 124 may be attached to the top case housing 102 and/or the bottom case housing 104. In some embodiments, the FPC connector 124 may be removably attached to the back side of the top case housing 102. The FPC connector 124 may also attach to the grip area of the top case housing 102. The FPC connector 124 may be used to connect sensors on the interactive screen 106 to a printed circuit board.

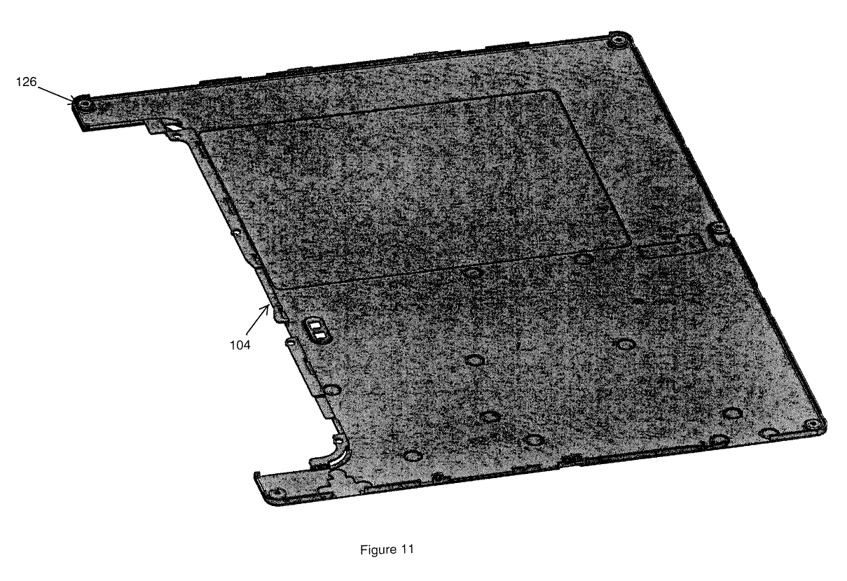

FIG. 11 is an illustration of a detailed view of a bottom case housing 104 of a thin electronic reader device 100 according to an embodiment. FIG. 11 illustrates the front side of the bottom case housing 104. As illustrated, the bottom case housing 104 may include one or more openings 126 where a connector may be attached.

In some embodiments, the top case housing 102, the bottom case housing 104, and the interactive screen 106 are connected. One or more connectors may go through the bottom case housing 104. In some embodiments, the one or more connectors may go through the openings 126 of the bottom case housing 104. The one or more connectors may extend through and/or attach to the top case housing 102. In some embodiments, the one or more connectors may extend through and/or attach to the one or more connection points 120 of the top case housing 102. The one or more connectors may connect to the interactive screen 106. In some embodiments, the one or more connectors may be attached to one or more bosses 122 of the interactive screen 106. The one or more connector may be screws or any other attachment mechanism.

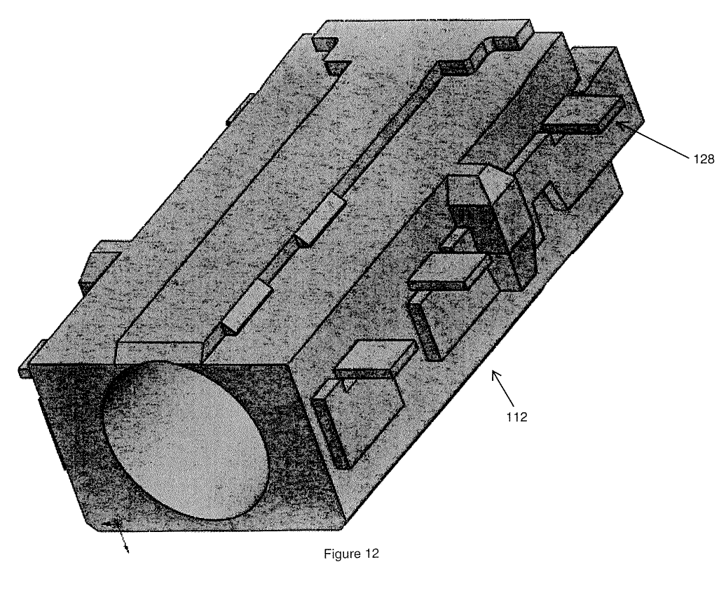

FIG. 12 is an illustration of a detailed view of an audio jack 112 of a thin electronic reader device 100 according to an embodiment. The audio jack 112 may enable audible sound output from the electronic reader device 100. In some embodiments, the audio jack 112 may include ridges or clips 128 that allow the audio jack 112 to easily attach to the bottom case housing 104 and/or the top case housing 102.

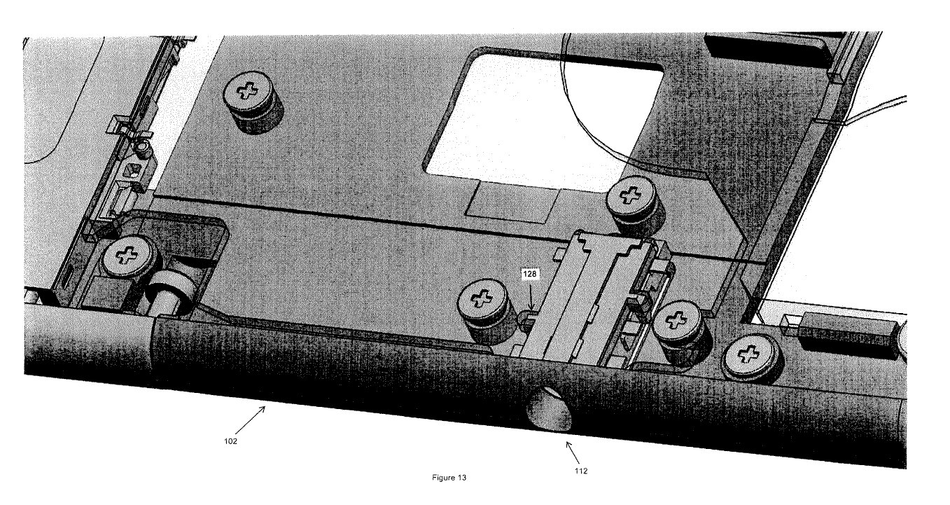

FIG. 13 is an illustration of a detailed view of an audio jack of a thin electronic reader device according to an embodiment. The audio jack 112 may be attached to top case housing 102 and/or the bottom case housing 104. As illustrated, in some embodiments, the audio jack 112 may be only attached to the top case housing 102. As illustrated, the ridges or clips 128 of the audio jack 112 allow the jack 112 to fit snugly within the top case housing 102. The audio jack 112 may also be secured to the top case housing 102 using a connector.

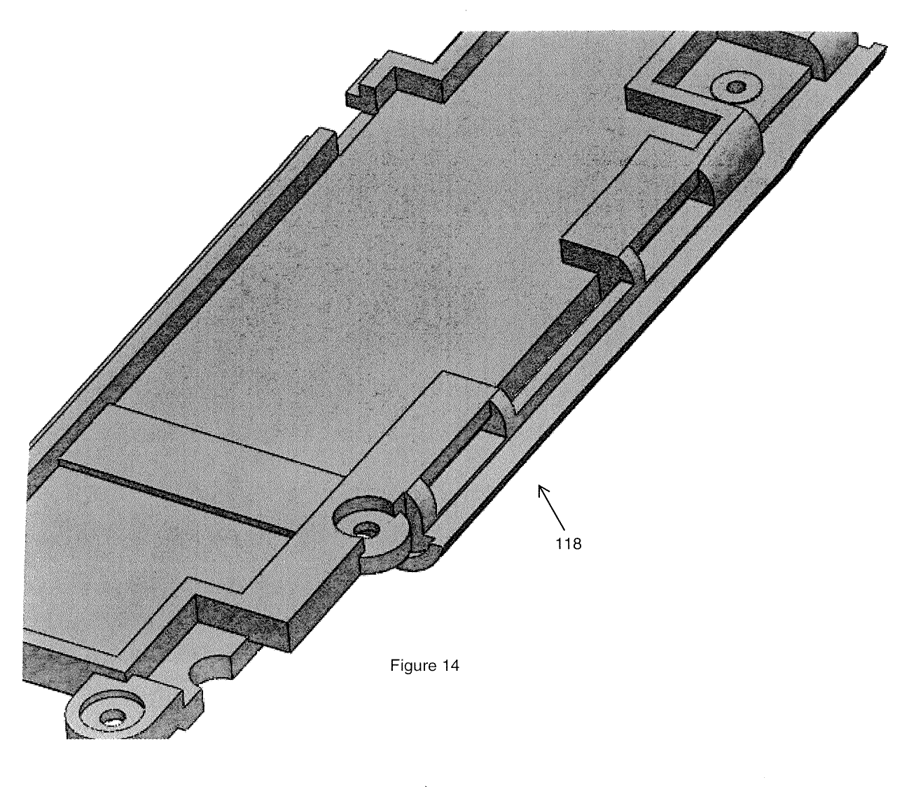

FIG. 14 is an illustration of a detailed view of a RF shield 118 of a thin electronic reader device 100 according to an embodiment. The RF shield 118 may be attached to the top case housing 102 and/or the bottom case housing 104. The RF shield 118 may be metal. The RF shield 118 may also provide electromagnetic shielding. The RF shield 118 may be used around the perimeter of the antenna to suppress inadvertent sensing of stray RF from other areas of the system. The RF shield 118 may also be used to prevent radiated RF from interfering with other elements of the system. In some embodiments, the RF shield 118 may include divots, connection points, or holes that allow the RF shield 118 to easily attach to the bottom case housing 104 and/or the top case housing 102. The RF shield 118 may attach to the top case housing 102 and/or the bottom case housing 104 using connectors.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

While the foregoing illustrates and describes exemplary embodiments of this invention, it is to be understood that the invention is not limited to the construction disclosed herein. The invention can be embodied in other specific forms without departing from its spirit or essential attributes.

What is claimed is:

1. An electronic reader device comprising:
a top case housing having a front side and a back side;
a bottom case housing having a front side and a back side, the front side of the bottom case housing being removably attached to the back side of the top case housing;
an electronic paper display nested within the top case housing, the electronic paper display adapted to display viewable images; and
an interactive screen being affixed to the front side of the top case housing, the interactive screen adapted to overlie the electronic paper display;
wherein the electronic reader device has a reduced thickness, the electronic reader device being configured to be no more than 0.35 inches thick.

2. The electronic reader device of claim 1, wherein the electronic reader device is between 0.04 inches and 0.35 inches thick.

3. The electronic reader device of claim 1, further comprising:
an audio jack affixed to the top case housing, the audio jack being configured to fit within the electronic reader device, the audio jack being further configured to permit audible sound from the electronic reader device.

4. The electronic reader device of claim 1, further comprising:
a battery configured to fit within the electronic reader device, the battery being further configured to supply power to the electronic reader device.

5. The electronic reader device of claim 1, further comprising:
an antenna nested within the electronic reader device, the antenna being capable of receiving and transmitting communication signals.

6. The electronic reader of claim 5, wherein the communication signals received and transmitted by the antenna occur over a communications network.

7. The electronic reader device of claim 5, further comprising:
an antenna cover configured to cover the antenna, the antenna cover being further configured to attach to the bottom case housing and the top case housing.

8. The electronic reader device of claim 5, further comprising:
a RF shield attached to the top case housing, the RF shield configured to overlie the antenna.

9. The electronic reader device of claim 1, further comprising:
a moveable wheel attached to the top case housing, the moveable wheel being capable of allowing interaction with the electronic reader device.

10. The electronic reader device of claim 9, wherein the moveable wheel allows a user of the electronic reader device to turn a page of an electronic publication that is viewable in the electronic reader device.

11. The electronic reader device of claim 1, wherein the interactive screen is a touch screen.

12. An electronic reader device comprising:
a top case housing having a front side and a back side;
a bottom case housing having a front side and a back side, the front side of the bottom case housing being removably attached to the back side of the top case housing;
an electronic paper display nested within the top case housing, the electronic paper display adapted to display viewable images; and
an interactive screen being affixed to the front side of the top case housing, the interactive screen adapted to overlie the electronic paper display;
a RF shield affixed to the top case housing;
an audio jack affixed to the top case housing, the audio jack being configured to fit within the electronic reader device;
wherein the electronic reader device has a reduced thickness, the electronic reader device being configured to be no more than 0.35 inches thick.

13. The electronic reader device of claim 12, wherein the electronic reader device is between 0.04 inches and 0.35 inches thick.

14. The electronic reader device of claim 12, further comprising:
an antenna nested within the electronic reader device, the antenna being capable of receiving and transmitting communication signals.

15. The electronic reader of claim 14, wherein the communication signals received and transmitted by the antenna occur over a communications network.

16. The electronic reader device of claim 14, further comprising:
an antenna cover configured to cover the antenna, the antenna cover being further configured to attach to the bottom case housing and the top case housing.

17. The electronic reader device of claim 12, further comprising:
a battery configured to fit within the electronic reader device, the battery being further configured to supply power to the electronic reader device.

18. The electronic reader device of claim 12, further comprising:
a moveable wheel attached to the top case housing, the moveable wheel being capable of allowing interaction with the electronic reader device.

19. The electronic reader device of claim 18, wherein the moveable wheel allows a user of the electronic reader device to turn a page of an electronic publication that is viewable in the electronic reader device.
